(19) United States
(12) Patent Application Publication
(10) Pub. No.: US 2007/0079086 A1
(43) Pub. Date: Apr. 5, 2007

(54) System for archival storage of data

(75) Inventors: You Wang, Longmont, CO (US); Steven Fredrick Hartung, Boulder, CO (US); Kenneth D. Merry, Lafayette, CO (US); Thomas Gabrysch, Littleton, CO (US)

Correspondence Address: Trellis Intellectual Property Law Group, PC, 1900 EMBARCADERO ROAD, SUITE 109, PALO ALTO, CA, 94303, US

(73) Assignee: COPAN Systems, Inc., Longmont, CO (US)

(21) Appl. No.: 11/540,494

(22) Filed: Sep. 28, 2006

Related U.S. Application Data
(60) Provisional application No. 60/722,215, filed on Sep. 29, 2005.
(60) Provisional application No. 60/730,288, filed on Oct. 25, 2005.

(51) Int. Cl. G06F 12/16

(52) U.S. Cl. 711/161

(57) ABSTRACT

A secondary storage system for maintaining data units transferred from a primary storage system is provided. The secondary storage system includes secondary storage media. Not all of the secondary storage media are powered on at the same time. The secondary storage media includes at least one storage medium that is always in the powered-on mode. Metadata is stored in one or more of at least the one storage medium in the powered-on mode. The metadata includes at least one attribute of a data unit stored in a secondary storage medium that is in the lower power mode of operation than at least the one storage medium that is always in the powered-on mode.

### CROSS REFERENCES TO RELATED APPLICATIONS

This application claims priority to the following applications, hereby incorporated by reference, as if set forth in full in this application:

U.S. Provisional Patent Application Ser. No. 60/722,215, entitled ‘SYSTEM FOR ACHIVAL STORAGE OF DATA’, filed on Sep. 29, 2005 and U.S. Provisional Patent application Ser. No. 60/730,288, entitled ‘USER INTERFACE FOR ARCHIVAL STORAGE OF DATA’, filed on Oct. 25, 2005.

### BACKGROUND

Particular embodiments generally relate to data storage systems, and more particularly, to archival systems.

It is often critical to make back-up or archival copies of data. Archiving can free a primary storage system to accommodate additional data. Archiving can also enable data to be restored after it is lost, destroyed or corrupted. The system efficiency of data that is accessed infrequently can also be increased.

A typical archival system uses an array of disk drives as its primary storage system. Data from the primary storage system is copied or transferred to an archival system. The archival system is usually larger, slower and less costly than the primary system. For example, the archival system can use tape drives, slower disk drives, optical drives, etc., to store data. In other words, the archive storage system can be designed to cost less per storage unit and consume less power. Care must be taken to create an efficient archive file system so that storage and retrieval between the primary and archive systems does not interfere with the overall operation of a computer system that the archive system is designed to support.

The ability of a system administrator to manage archive tasks, view, organize and restore archived files and directories, and to perform other functions is important for the smooth operation of many types of computer applications.

### SUMMARY

In accordance with various embodiments, a secondary storage system for maintaining data units transferred from a primary storage system is provided. The secondary storage system includes a secondary storage media. All the secondary storage media are not powered-on at the same time. Further, the secondary storage media includes at least one storage medium that is always in the powered-on mode. The secondary storage system also includes metadata stored on one or more of the at least the one storage medium that is always in the powered-on mode. The metadata includes at least one attribute of a data unit that is stored in a secondary storage medium that is in a lower power mode of operation than the at least one storage medium that is always in the powered-on mode.

In accordance with an embodiment, a method for maintaining data units transferred from a primary storage system in a secondary storage system is provided. The secondary storage system includes secondary storage media, which are not all in a powered-on mode at the same time. Further, the secondary storage media includes at least one storage medium that is always in the powered-on mode. The method includes determining the metadata of one or more data units in the secondary storage media. The metadata includes the attributes for the data units in at least one of the secondary storage media that is in a lower power mode than the at least one storage medium that is always in the powered-on mode. Moreover, the method includes storing the metadata in the at least one storage medium that is always in the powered-on mode. The attributes allow information about the data units in the at least one of the secondary storage medium that is at the lower power mode to be determined.

### BRIEF DESCRIPTION OF THE DRAWINGS

Various embodiments of the present invention will hereinafter be described in conjunction with the appended drawings, provided to illustrate and not to limit the present invention, wherein like designations denote like elements, and in which:

FIG. 1 is a block diagram illustrating a general structure of an archival data storage system connected with a client device, in accordance with various embodiments.

FIG. 2 is a block diagram illustrating process modules in a rack, in accordance with an embodiment.

FIG. 3 is a block diagram illustrating a secondary storage system for storing data units is provided, in accordance with an embodiment.

FIG. 4 is a block diagram illustrating an archival system for archiving data units, in accordance with an embodiment.

FIG. 5 is a flowchart illustrating a method for maintaining data units in a secondary storage system, in accordance with various embodiments.

FIG. 6 is a flowchart illustrating a method for providing information about a data unit, in accordance with an embodiment.

FIG. 7 is a diagram illustrating a scalable archival system, in accordance with an embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment described here. This disclosure is intended to cover all modifications, equivalents and alternatives falling within the scope of the present invention, as defined by the appended claims.

### DETAILED DESCRIPTION OF EMBODIMENTS

One or more embodiments of the invention are described below. It should be noted that these and any other embodiments described below are exemplary and are intended to be illustrative of the invention rather than limiting.

Embodiments of the present invention provide a method, system and computer program product for a system for archival storage of data. The system for archival storage of data is used for archiving various files from a primary storage system in a secondary storage system, retrieving various files from the secondary storage system to a primary storage system and managing the files.

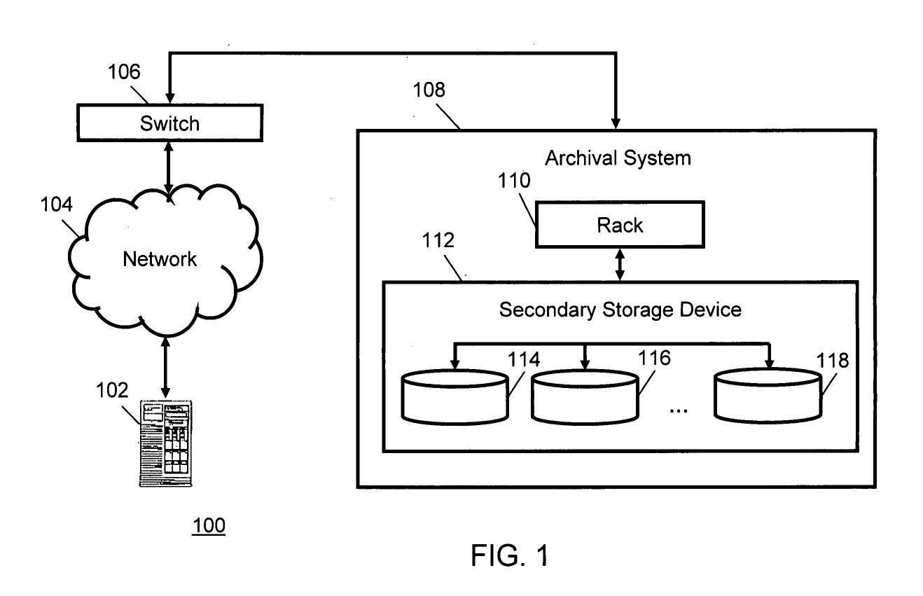

FIG. 1 is a block diagram illustrating a general structure of an archival data storage system connected with a client device, in accordance with various embodiments. Archival data storage system 100 includes a customer system 102, a network 104, a switch 106, and an archival system 108. Archival data storage system 100 can include multiple customer systems and multiple archival systems. These multiple customer systems can communicate with the multiple archival systems via network 104. Examples of network 104 include, but are not limited to, a mobile network, a personal area network (PAN), a local area network (LAN), a metropolitan area network (MAN), the Internet, and a wide area network (WAN). In an embodiment, network 104 can be a combination of one or more of the above-mentioned networks.

Customer system 102 can be operationally coupled with a primary storage system (not shown in FIG. 1). Examples of customer system 102 include, but are not limited to, a server, a Personal Computer (PC), a laptop, and a Personal Digital Assistant (PDA). In an embodiment, the customer system 102 can include the primary storage system. Examples of the primary storage system include, but are not limited to, hard disks, optical disks and magnetic tapes.

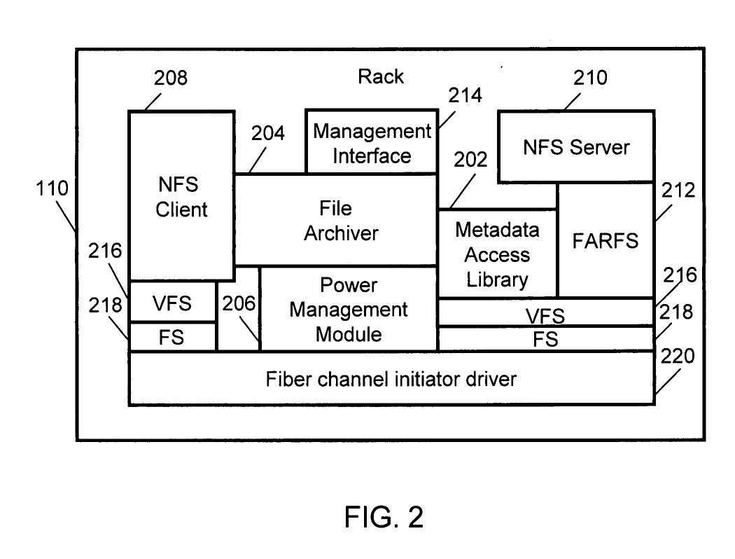

The primary storage system can store data units, such as files and directories. There may be a limit to the extent of data that can be stored in the primary storage system, for example, the maximum capacity to store in the hard disk may be 80 Gigabytes. The data units can be archived from the primary storage system to archival system 108. In an embodiment, a gigabit Ethernet switch can connect network 104 with archival system 108. The archival system 108 includes a rack 110 and a secondary storage system 112. The archived data files can be stored in the secondary storage system 112. Rack 110 can be used to implement various operations like archiving or retrieving data units stored at the archival system 108. The rack 110 can also power-on a secondary storage media that is in a lower power mode of operation. Rack 110 has one or more processing modules that are described in detail in conjunction with FIG.2.

Secondary storage system 112 can include a secondary storage media, having a first secondary storage medium and a second storage medium. In an embodiment, the secondary storage system 112 can include shelves such as a first shelf 114, a second shelf 116, and a third shelf 118. It should be appreciated that the secondary storage system 112 can have more than or fewer than three shelves. The first secondary storage medium, such as first shelf 118, can be powered-on all the time. On the other hand, other shelves, such as second shelf 114 and third shelf 116, can be in a lower power mode of operation. In an embodiment, the second secondary storage medium may be in a lower power mode of operation as compared to the first secondary storage medium. For example, the second secondary storage medium may be spinning at a lower speed or may be idle as compared to the first secondary storage medium. Further, the lower power mode of operation may include a powered off state or standby state. The second secondary storage medium can be powered-on from a lower power mode of operation on a need basis. For example, the one or more disk drives of the plurality of secondary storage media 112 containing the data units may be powered-on from a lower power mode of operation when a user sends a request to retrieve data units from the second secondary storage media.

Access to the data units from the secondary storage medium in the lower power mode of operation may be slower than if the second storage medium is powered on. In an embodiment, archival system 108 is based on a power-managed Redundant Array of Independent/inexpensive Disks (RAID) system or a power-managed Massive Array of Idle Disks (MAID) system.

In a power-managed storage system, only a limited number of storage devices are powered on at a time, according to a maximum permissible power consumption or “power budget.” Power-managed RAID systems are described in, for example, U.S. Pat. No. 7,035,972, entitled ‘Method and Apparatus for Power Efficient High-capacity Storage System’, which is incorporated herein by reference, as if set forth in this document in full for all purposes.

In an embodiment, an input/output (I/O) coalescing system may be used to access data units from the MAID portion of the system. This technique avoids powering drives on and off unnecessarily by re-ordering I/O requests into clusters that will access the same drives at the same time, rather than in the order they were originally received.

Metadata of the data units stored on the secondary storage system 1 12 can be stored at the first secondary storage medium that is powered on at all the times. The metadata can include one or more attributes of the data units. The metadata may be used for viewing attributes of the data units stored at the second secondary storage medium even when the second secondary storage medium is in a lower power mode of operation.

Metadata represents attributes of a data unit that can be used to identify the data unit. Attributes of the data unit include name of the data unit, owner or author of the data unit, a creation or/and last modification date of the data unit, size of the data unit, etc. In an embodiment, a query or request for archiving or retrieving the data units that are stored on the secondary storage system may be received. The query can be submitted by using a graphical user interface (GUI) in customer system 102. For example, all data units with an extension ‘.txt’ can be searched from the data units that are stored in at least one of primary storage system and secondary storage system 112. Further, a view of the data units that are stored on the secondary storage media can be provided even when the one or more disk drives on which the data unit is stored are in a lower power mode of operation. The metadata of the archival system for storage of data 100 can be stored on the first secondary storage medium that is always powered-on. The metadata can store the information about the data units that are stored on the second secondary storage medium that is in a lower power mode of operation. The second secondary storage medium may not be powered-on for viewing the data units that are stored on the second secondary storage medium. The metadata is used to provide attributes for the data units stored on the secondary storage medium. The view is created using the attributes without the need to power on the second secondary storage medium. The archival system for storage of data 100 can conduct various operations on the data units with the help of the metadata without the need to power on the second secondary storage medium. However, the second secondary storage medium will need to be powered on for reading the contents of the data unit that are stored on the second secondary storage medium. Further, the second secondary storage medium can be searched for data units with the help of the metadata that is stored on the first secondary storage medium that is always powered on. The second secondary storage medium need not be powered on for searching the data units that are stored on the second secondary storage medium that is in a lower power mode of operation.

FIG. 2 is a block diagram illustrating process modules in the rack 110, in accordance with an embodiment. Rack 110 includes process modules such as a Metadata Access Library (MAL) 202, a file-archiver 204, and a power management module 206. MAL 202 can store metadata that includes attributes and various parameters of the data units that are necessary at the directory level, to view, identify and perform basic data-manipulation operations. The view may provide different organizations of data. The basic data-manipulation operations that can be performed at the archival system 108 can include designating data units for archival tasks, retrieving data units from secondary storage system 112 to the primary storage system, and so forth.

Metadata can be used by file-archiver 204 to execute a query on data units stored in secondary storage system 112. File-archiver 204 can also migrate or transfer data files from the original user data location in the primary storage system to secondary storage system 112, leaving the original data files unchanged. In another embodiment, the archival system for storage of data 100 can be configured such that the data files that are archived by file-archiver 204 from the primary storage system to secondary storage system 112 are deleted from the primary storage system.

Further, file archiver 204 uses metadata of the data units that are stored on the first secondary storage medium that is always powered on. The metadata, as described above, contains information regarding the data units that are stored on the second secondary storage medium that is in a lower power mode of operation. In addition to the information of the data units that are stored on the second secondary storage medium, metadata contains a location of the data units. When the file archiver 204 receives a request to view the data units, the details of the data units that are stored on the second secondary storage medium can be displayed to the user of the archival system for storage of data 100 with the help of the metadata. The second secondary storage medium need not be powered-on for viewing the information pertaining to the data units. In addition to the information of the data units, the location of the data units can also be displayed to the user of the archival system for storage of data 100 with the help of the metadata. Similarly, when a read request for the data units is received at the file archiver 204, the file archiver 204 identifies the location of the data units with the help of the metadata. The second secondary storage medium, on which the data unit is stored, is then powered-on from the lower power mode of operation to enable read of the data units to the user of the archival system for storage of data 100.

The second secondary storage medium that is in the lower power mode of operation may not be powered-on for viewing the data units. However, the second secondary storage medium may need to be powered-on when the data units stored on the second secondary storage medium are retrieved in response to a query. In an embodiment, power management module 206 can be configured for the transition of the second secondary storage medium that is at the lower power mode of operation to a powered-on mode. The second secondary storage medium can be powered-on before a request for a data unit stored in secondary storage medium is received.

In an embodiment, rack 110 can also include a network file system (NFS) client 208, an NFS server 210, an File Archiver Read only File System (FARFS)212, a management interface 214, a virtual file system (VFS) 216, a file system 218 such as a UNIX file system (UFS), and a Fiber-channel driver 220. FARFS 212 is a stackable file system layer embedded into the operation system above VFS. NFS client 208 can send a request for a data unit, such as a data file, to be copied or moved from the primary storage system to secondary storage system 112. The request for the archiving or retrieving the data units can be processed by NFS server 210. Management interface 214 allows a human user of archival system for storage of data 100 to view the metadata. Management interface 214 can also enable the human user to view results of a query executed to retrieve data units. The human user can then select a result from management interface 214 and access the corresponding data units. In an embodiment, fiber channel drivers 220 can connect fiber channel interconnect, to operatively couple rack 110 with secondary storage system 112. The one or more rack modules can be functionally coupled with VFS 216 and file system 218 to interact with secondary storage system 112. Further, the fiber channel interconnect is capable of installing many-to-many connections.

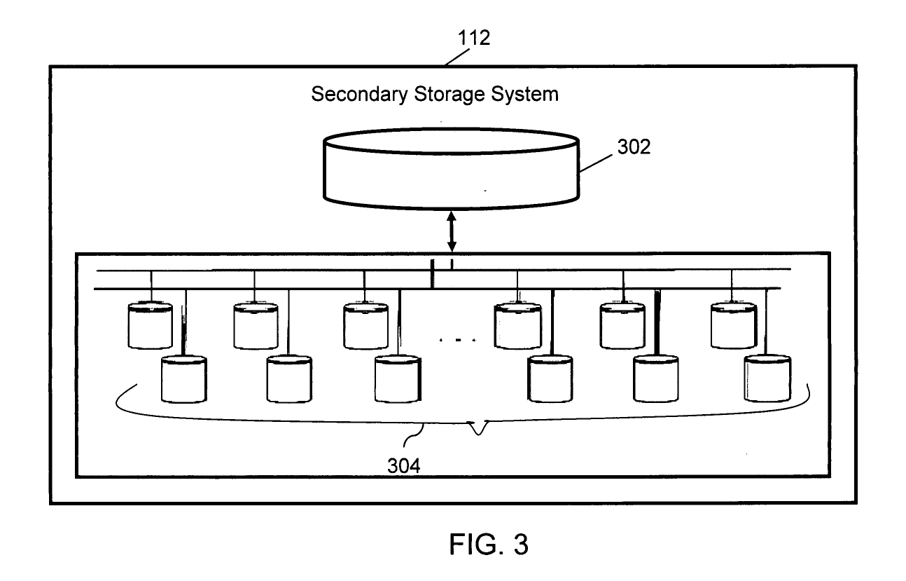

FIG. 3 is a block diagram illustrating a secondary storage system for storing data units, in accordance with an embodiment. The secondary storage system 112 includes a first and second secondary storage media that can be used for storing the data units. The first storage medium is in the powered-on mode at all times. On the other hand, the second secondary storage medium can be in a lower power mode of operation at a given time and can be brought into the powered-on mode on a need basis. The first secondary storage medium can include one or more shelves for storing the data units. For example, the first secondary storage medium is shown to include the first shelf 302 that is in the power-on mode of operation at all times. Similarly, the second secondary storage medium may also include one or more shelves for storing the data units. The one or more shelves for storing the data units are shown as data shelves 304 in the FIG. 3. However, it should be appreciated that the number of data shelves that can be included in the second secondary storage medium may be more than or less than the ones that have been shown in FIG. 3.

Metadata of the data units is stored in the first secondary storage medium that is always in the powered-on mode. The first secondary storage medium that is in a power-on mode of operation may also store the data units. Metadata can include basic file attributes such as the name of the data unit, the creation date and/or modify date of the data unit, the size of the data unit, the type of the data unit, and so forth. Additionally, depending on specific implementation requirements, more attributes can be defined and can be associated with the data units. Such attributes can also be appended to the data units to be parts of the metadata. For example, in execution of a query, it may be useful to include the name of the author or creator associated with the data unit as part of the metadata of the data unit. Keywords that can identify the data units may also be incorporated as the metadata of the data unit. The keywords and other attributes of the data unit can be defined by the user and can be included in the metadata for the data unit. For example, the contents of a data unit can be defined, so that keyword-searching on archived data units can be performed, even when the data contents, for example, the actual file contents, are archived on the second secondary storage medium that is at the lower power mode of operation. In this manner, large amounts, for example, terabytes, of data units can be archived on the second secondary storage medium that is at the lower power mode of operation, while many basic functions can still be performed on the data units.

In an embodiment, the metadata of the data units may include versioning information that can be used to provide information about the data unit. For example, multiple versions of the same file can be archived on the secondary storage system 112. A job description of an archiving or retrieving task can be specified, such that the system can store all the copies of a data unit, or that it may keep only ‘n’ (where n≧1; and n is an integer number) copies of the data unit. When the ‘n’ copy threshold is reached, archival system 108 may delete the oldest version each time a new version of the data unit is archived in archival system 108.

In an embodiment, a re-ordering mechanism may be required for ordering the archiving or retrieving requests that are received at the secondary storage system 112, when multiple requests are being received at the secondary storage system 112 from the customer system 104. The re-ordering mechanism can be configured in secondary storage system 112 to reorder a plurality of requests from one or more customer systems. The order of the requests can be classified as a first order request, a second order request, a third order request, and so on. The first order request can allow a portion of a plurality of requests to access a first storage medium in the first and second secondary storage media in order. Further, the second order request can allow another portion of the plurality of requests to access a second storage medium in the first and second secondary storage media. The re-ordering of the plurality of requests can be done in order to limit the number of times the same storage medium is powered-on from a lower power mode of operation. Further, the re-ordering of the plurality of requests can be configured in order to optimize the number of times of powering on and powering off of the same storage medium. This may be required in order to enforce the power budget while reducing the number of changes in power state of the storage media, which typically reduces the lives of the storage media.

In another embodiment of the present invention, a caching mechanism can be configured for the secondary storage system 112. The caching mechanism can be configured in such a manner that a recently accessed file is cached in the first secondary storage medium that is always powered-on. Such a caching mechanism allows faster access of the data units that are being accessed frequently. At the same time, the caching mechanism reduces the frequent powering-on and powering-off of the second secondary storage medium that is in a lower power mode of operation at a given time.

Further, a file-archiver mechanism can be configured at the secondary storage system 112. The file-archiver mechanism groups one or more data units stored in the second secondary storage medium when a particular group of data units is being accessed frequently. The one or more data units that are stored in the second secondary storage medium that is in a lower power mode of operation may be cached on the first secondary storage medium so that frequent powering-on and powering-off of the second secondary storage medium can be minimized.

In an embodiment, a powering-on mechanism can also be configured for transition of the secondary storage medium that is at the lower power mode of operation from the lower power mode of operation to a powered-on mode based on a search on the metadata. The powering-on mechanism can be configured in such a manner that the power mode of the secondary storage medium can be changed before a request for a data unit is received at the secondary storage system 112. The powering-on mechanism can allow to optimize the number of times the second secondary storage medium needs to be powered-on from the lower power mode of operation. However, the search can still be performed for data units in the secondary storage medium that is in the lower power mode of operation.

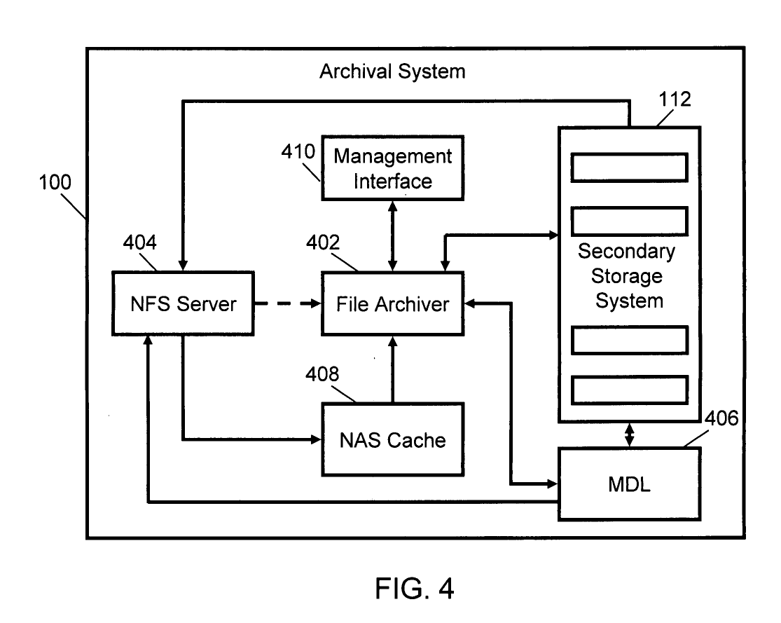

FIG. 4 is a block diagram illustrating an archival system for archiving data units, in accordance with an embodiment. Archival system for storage of data 100 can include a file-archiver 402, a network file system (NFS) server 404, metadata library (MDL) 406, a network-attached storage (NAS) cache 408, a management interface 410, and the secondary storage system 1 12. File archiver 402 can be functionally coupled with NFS server 404. NFS server 404 can access data files in the primary storage system and metadata stored in MDL 406. File-archiver 402 can move or copy data files from the primary storage system to NAS cache 408. In an embodiment, NAS cache 408 can be an off-shelf NAS box, embedded as a cache in the archival system 108. File archiver 402 can determine the metadata of the data files stored in NAS cache 406. This metadata can be stored in MDL 406. Further, file archiver 402 can use metadata and the data units stored in NAS cache 408 to run a search. For example, the archival system for storage of data 100 can be configured to retrieve names of all the data units with an extension ‘.mpg’ in the secondary storage system 112. In an embodiment, a compliance policy can be implemented to archive the data units from NAS cache 408 to secondary storage device 112. In an embodiment, data units stored in NAS cache 408 can be scheduled to be archived from NAS cache 408 to secondary storage system 112.

In another embodiment, at the completion of an archival task of data units from the customer system 104 to the secondary storage system 112, a configuration directory can be created in NAS cache 408. The configuration directory can have information regarding the structure in which the data units have been archived. Further, the configuration directory may include optional compliance-configuration data. The compliance-configuration data can specify an archiving structure and the compliance policy associated with the archiving task. The configuration directory can be used by file-archiver 402 to archive more data units from the customer system 104 to the secondary storage system 112.

In accordance with an embodiment, management interface 410 can create and manage the compliance policy. Examples of a management interface 410 include a graphical user interface (GUI), a command line interface, a UNIX command interface, etc. The compliance policy can contain compliance configurations or rules. The compliance policy can be stored in NAS cache 408. Compliance configuration may contain multiple policy sets, so that different policy sets can be applied to different sets of data units based on user preferences. An example of the compliance policy can be scheduling the archiving of the data units based on data traffic in network 104.

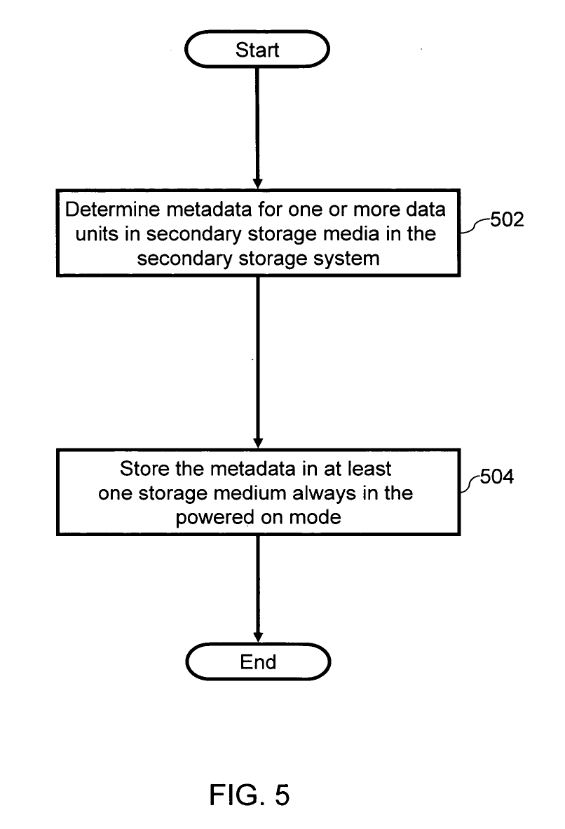

FIG. 5 is a flowchart illustrating a method for maintaining data units in a secondary storage system, in accordance with various embodiments. The data units, such as data files, can be archived from a primary storage system to secondary storage system 1 12. The secondary storage system 112 includes the first secondary storage medium and the second secondary storage medium. The first secondary storage medium is powered on all the time, and at the same time, the second secondary storage medium is in the lower power mode of operation and can be powered on a need basis. At step 502, metadata is determined for one or more data files stored in secondary storage system 112. The metadata includes one or more attributes of a data unit that provides information about a data unit. In an embodiment, user-defined information and versioning information can also be included in the metadata of the data units.

At step 504, the metadata for the data units is stored in the at least one storage medium that is always in the powered-on mode, i.e., the first secondary storage medium. The one or more attributes that are stored in the metadata may also include information about the data units that are stored in the at least one of the secondary storage medium that are in the lower power mode of operation, i.e., in the second secondary storage medium. In an embodiment, the archival system of storage of data can receive a query for archiving and retrieving the data units that are stored at the first and second secondary storage media. The query can be in terms of the one or more attributes that can identify the data units that are stored in the secondary storage system 1 12. Further, the one or more attributes that are provided in the query are used to provide information about the data units. The information about the data units can be provided at the archival system for storage of data 100 even when the second secondary storage medium is in a lower power mode of operation. The information about the data units can be provided at the archival system for storage of data 100 in real time on the basis of the query.

The one or more disk drives that are in the lower power mode of operation can also be determined at the archival system for storage of data 100. The data units that are stored on the customer system 104 can also be designated to be archived to the second secondary storage medium that is in a lower power mode of operation. In an embodiment, the unallocated space in the first secondary storage medium that is powered-on all the time may be determined. Further, storage of the metadata may be based on the unallocated space determined in the first secondary storage medium. For example, 20 Giga byte of unallocated space may be determined on the first secondary storage medium that is in a powered-on mode. Metadata of 12 Gigabyte can be stored in the unallocated space on the first secondary storage medium.

In an embodiment, data files can be migrated from one power-managed disk to another power-managed disk or to group files that are accessed for reading or retrieval together. The metadata is updated to reflect the new position of the data units before the data unit is re-located, making the migration of the data units invisible to the user. Such a practice enables efficient power consumption of the secondary storage system 112 when the same groups of data units are accessed frequently.

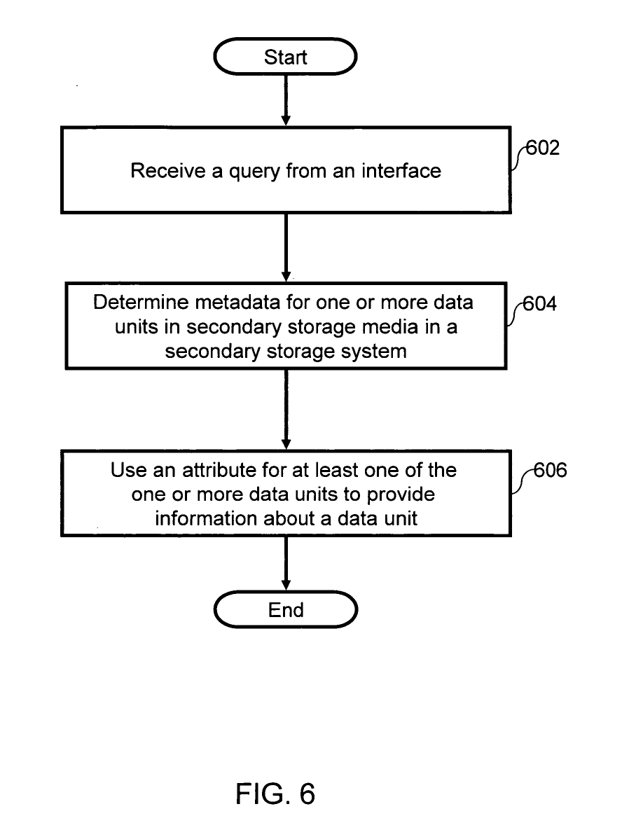

FIG. 6 is a flowchart illustrating a method for providing information about a data unit, in accordance with another embodiment. The information about the data units stored at the first and second secondary storage media of the archival system for storage of data 100 can be determined by a query for retrieving the data units. The query can be for the data units stored at the first secondary storage medium that is powered-on at all times or for the data units stored at the second secondary storage medium that is in a lower power mode of operation at the same time.

At step 602, a query is received from a user interface in customer system 102. The request can be received from a GUI or a command line interface. At step 604, metadata stored in the first secondary storage medium that is powered-on all the time is determined based on the query. The archival system for storage of data units 100 may determine the metadata of the data units that are stored on the secondary storage system 112. The metadata may contain information about the data units that are stored on the second secondary storage media that is in a lower power mode of operation.

At step 606, one or more attributes of the data files are used to provide information about data units. For example, the name of the data unit and the size of the data unit can be used in order to determine the data units stored in the second secondary storage media that is in a lower power mode of operation. A view of the data units may be provided using the GUI or a command line interface. Further, the GUI or the command line interface may be used for retrieving the data units that are stored on the second secondary storage media that is in a lower power mode of operation. For retrieving the data units, the second secondary storage media may need to be powered-on from the lower power mode of operation.

In an embodiment, GUI can further be used to create new metadata trees by copying files from the main metadata tree. A view of the data units can be determined from the metadata of the data files in different tree structures. In this way, data units can be reorganized into new views to serve a specific need. The main metadata tree is not altered in this process. Each new metadata tree can be presented as a separate network file system from the main metadata tree, thereby enabling different access limitations to be configured to different views. In an embodiment, views of the data units stored at the secondary storage system 112 can be presented through a graphical user interface (GUI) in customer system 102.

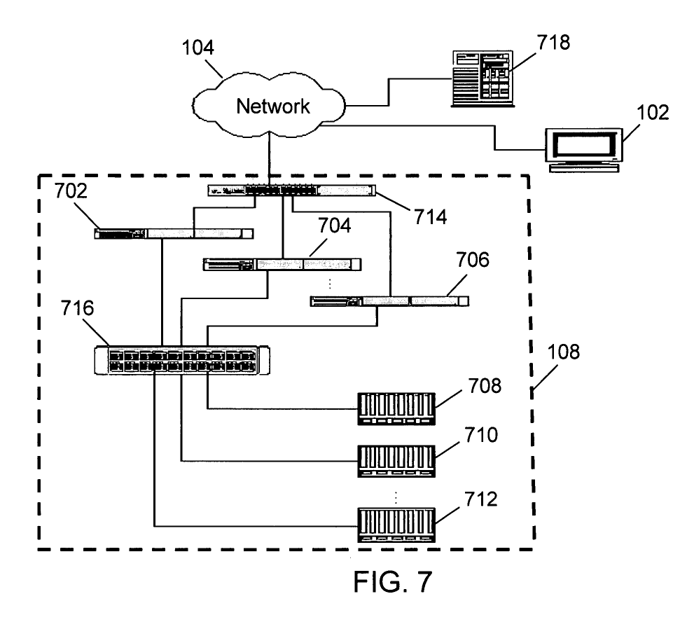

FIG. 7 is a diagram illustrating a scalable archival system, in accordance with an embodiment. The archival system 108 may be required to be scaled up for various user requirements. Examples of user requirements include scaling up of the load for the archival system 108, speed of the functioning of the archival system 108, etc. Based on various user requirements, archival system 108 can scale up in request processing speeds, for example, retrieving data, archiving data, running queries and so forth. Further, archival system 108 can scale up its data storage capacity by using multiple storage devices. The scalable archival system may include multiple racks, such as a first rack 702, a second rack 704, and a third rack 706, and multiple secondary storage shelves, such as first shelf 708, a second shelf 710, and a third shelf 712. In an embodiment, the multiple racks and the multiple shelves can be located in different geographical locations.

One or more file-archivers in one or more of the multiple racks can access metadata stored in the first secondary storage medium. The metadata can be stored in more than one secondary storage medium that is in powered-on mode. The metadata contains information pertaining to the data units that are stored in the first and second secondary storage media. The first secondary storage medium can be powered-on at all times and at the same time the second secondary storage medium can be in the lower power mode of operation.

In various embodiments, there can be a greater or fewer numbers of racks and shelves as compared to the ones that are shown in FIG. 7. The one or more multiple racks can be implemented in a processor node, such as a server. A gigabit Ethernet switch 714 may be employed to connect the first rack 702, the second rack 704, and the third rack 706 with network 102. The multiple racks can be connected by a FC switch 716 to the multiple shelves. The one or more racks of the multiple racks can access one or more shelves of the multiple shelves. The multiple racks can provide more bandwidth as compared to a single rack of a storage media.

Further, the job processing performed by archival system 108 can be distributed across the multiple racks. For example, in the archival system 108 shown in FIG. 7, the job processing can be distributed in the first rack 702, the second rack 704 and the third rack 706. In an embodiment, a task at the archival system for storage of data 100 can be initiated by using a GUI or a command line interface present in one of the processor nodes. The task can be an archiving or a retrieving task that can be created for the data units stored on the secondary storage system 112.

The processor node, along with the new retrieval task, can check a mailbox to determine how busy the other processor nodes are by examining the state of the currently active tasks. In an embodiment, the mailbox can be stored in the processing device (not shown in FIG. 7), which can be a computer or a server. The mailbox can be a frequently updated storage system in archival system 108. The processor node with the new task then divides the new task into sub-tasks and assigns them to underutilized nodes by placing the sub-task definitions in one or more mailboxes of the other nodes. The nodes periodically monitor the progress of the other nodes by examining the state information of the other nodes in the shared mailbox locations. In the event a task stops due to a node failure, one of the other nodes can assume the responsibility for the task and can take ownership of completing the unfinished operations or by restarting any operations that failed in an unrecoverable fashion.

In an embodiment, it can be determined which processor node is to take over a task by means of a priority sequence assigned at the time that the processor nodes are installed in file archival system 108, or alternatively through an arbitration scheme, based on the first unit, to acquire a shared lock that indicates ownership of the task. Thus, the clustered processor nodes provide scalable bandwidth while providing a high-availability (HA) architecture, where a single processor node failure does not result in the task coming to an end.

The number of hard disks that need to be kept powered on can change as metadata is added. Archival system 108 can predict when content data on data units that are stored on the secondary storage medium that is at lower power mode of operation will be needed and turn on the identified secondary storage media before an access. For example, if a search is performed by using keywords stored in metadata and the search is narrowed to a hundred or less results, the system can power on the second secondary storage media containing the data units corresponding to the results in anticipation of the access to the results. Powering on can be automatic, by user control, or by other means.

In various embodiments of the invention, different system architectures can be used. For example, the rack/shelf/modules/device arrangement of FIG. 1 need not be followed. Various features of embodiments of the invention may be used with any suitable architecture. Specific units or types of data referred to herein are merely used as examples, and any suitable type or amount of data can be substituted. For example, although embodiments of the invention have been described with respect to file management, features of the invention can be similarly applied to portions or groups of files, blocks, sectors, disks, or other units of information. Any type of content can be used, such as image, audio, executable program code, text, numerical data, etc.

The system, as described in the present invention or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention. Functions described herein can be achieved in hardware, software, or a combination of both, as desired. Specific programming languages, statements, syntax, or other details of the software or software description can be changed as desired.

Although the invention has been described with respect to specific embodiments thereof, these embodiments are descriptive and not restrictive of the invention. For example, it should be apparent that the specific values and ranges of the parameters could vary from those described herein.

Although terms such as ‘storage device,’ ‘disk drive,’ etc., are used, any type of storage unit can be adapted for use with the present invention. For example, disk drives, magnetic drives, etc., can also be used. Different present and future storage technologies can be used, such as those created with magnetic, solid-state, optical, bioelectric, nano-engineered or other techniques.

Storage units can be located either internally inside a computer or outside it in a separate housing that is connected to the computer. Storage units, controllers, and other components of systems discussed herein can be included at a single location or separated at different locations. Such components can be interconnected by any suitable means, such as networks, communication links or other technology. Although specific functionality may be discussed, such as operating at, or residing in or with specific places and times, it can generally be provided at different locations and times. For example, a functionality such as data protection steps can be provided at different tiers of a hierarchical controller. Any type of raid arrangement or configuration can be used.

In the description herein, numerous specific details are provided, such as examples of components and/or methods, to provide a thorough understanding of the embodiments of the present invention. One skilled in the relevant art will recognize, however, that an embodiment of the invention can be practiced without one or more of the specific details; or with other apparatus, systems, assemblies, methods, components, materials, parts, and/or the like. In other instances, well-known structures, materials or operations are not specifically shown or described in detail, to avoid obscuring aspects of the embodiments of the present invention.

A ‘processor’ or ‘process’ includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location or have temporal limitations. For example, a processor can perform its functions in ‘real time,’ ‘offline,’ in a ‘batch mode,’ etc. Moreover, certain portions of processing can be performed at different times and at different locations, by different (or the same) processing systems.

Reference throughout this specification to ‘one embodiment’, ‘an embodiment’, or ‘a specific embodiment’ means that a particular feature, structure or characteristic, described in connection with the embodiment, is included in at least one embodiment of the present invention and not necessarily in all the embodiments. Therefore, the use of these phrases in various places throughout the specification does not imply that they are necessarily referring to the same embodiment. Further, the particular features, structures or characteristics of any specific embodiment of the present invention may be combined in any suitable manner with one or more other embodiments. It is to be understood that other variations and modifications of the embodiments of the present invention, described and illustrated herein, are possible in light of the teachings herein, and are to be considered as part of the spirit and scope of the present invention.

It will also be appreciated that one or more of the elements depicted in the drawings/figures can also be implemented in a more separated or integrated manner, or even removed or rendered inoperable in certain cases, as is required, in accordance with a particular application. It is also within the spirit and scope of the present invention to implement a program or code that can be stored in a machine-readable medium, to permit a computer to perform any of the methods described above.

Additionally, any signal arrows in the drawings/figures should be considered only as exemplary, and not limiting, unless otherwise specifically noted. Further, the term ‘or’, as used herein, is generally intended to mean ‘and/or’ unless otherwise indicated. Combinations of the components or steps will also be considered as being noted, where terminology is foreseen as rendering unclear the ability to separate or combine.

As used in the description herein and throughout the claims that follow, ‘a’, ‘an’, and ‘the’ includes plural references, unless the context clearly dictates otherwise. In addition, as used in the description herein and throughout the claims that follow, the meaning of ‘in’ includes ‘in’ and ‘on’, unless the context clearly dictates otherwise.

The foregoing description of the illustrated embodiments of the present invention, including what is described in the Abstract, is not intended to be exhaustive or limit the invention to the precise forms disclosed herein. While specific embodiments and examples of the invention are described herein for illustrative purposes only, various equivalent modifications are possible within the spirit and scope of the present invention, as those skilled in the relevant art will recognize and appreciate. As indicated, these modifications may be made to the present invention, in light of the foregoing description of the illustrated embodiments of the present invention, and are to be included within the spirit and scope of the present invention.

Therefore, while the present invention has been described herein with reference to the particular embodiments thereof, latitude of modification, various changes and substitutions are intended in the foregoing disclosures. It will be appreciated that in some instances some features of the embodiments of the invention will be employed without the corresponding use of the other features, without departing from the scope and spirit of the invention, as set forth. Therefore, many modifications may be made, to adapt a particular situation or material to the essential scope and spirit of the present invention. It is intended that the invention is not limited to the particular terms used in the following claims and/or to the particular embodiment disclosed as the best mode contemplated for implementing the invention, which may include any and all the embodiments and equivalents falling within the scope of the appended claims.

We claim:

1. A secondary storage system for maintaining data units transferred from a primary storage system, the secondary storage system comprising:
secondary storage media, wherein not all of the secondary storage media are in a powered-on mode at the same time, wherein the secondary storage media includes at least one storage medium always in the powered-on mode; and
metadata stored on one or more of the at least one storage medium always in the powered-on mode, wherein the metadata includes at least one attribute of a data unit in a secondary storage medium that is in a lower power mode of operation than the at least one storage medium always in the powered-on mode.

2. The secondary storage system of claim 1, further comprising:
a management interface for allowing a human user to view the metadata.

3. The secondary storage system of claim 1, further comprising:
a management interface for allowing a human user to view the results of a query to retrieve data from the secondary storage system using the metadata.

4. The secondary storage system of claim 3, wherein the metadata includes user-defined information that is used to display the results of the query.

5. The secondary storage system of claim 3, wherein the metadata comprises versioning information that is used to display the results of the query.

6. The secondary storage system of claim 1, further comprising:
a management interface for allowing a human user to view the data in the storage system in different organizations dynamically based on a user request using the metadata.

7. The secondary storage system of claim 1, further comprising:
a file-archiver application for migrating data units from the primary storage system to the second storage system and where access to data unit on the secondary storage system is made transparent to a user of the data of the first storage system using metadata stored in the first storage system.

8. The secondary storage system of claim 1, wherein a data unit comprises a file.

9. The secondary storage system of claim 1, further comprising:
a management interface configured to display data units at a directory level using the metadata.

10. The secondary storage system of claim 1, further comprising:
a re-ordering mechanism configured to reorder a plurality of requests for data units in a first order different from a second order the plurality of requests were received, wherein the first order allows a portion of the plurality of requests to access a same storage medium in the secondary storage media in order.

11. The secondary storage system of claim 10, wherein re-ordering the plurality of requests limits the powering on and powering down of the same storage medium than if the plurality of requests were not reordered.

12. The secondary storage system of claim 1, further comprising:
a caching mechanism configured to cache a data unit in the storage medium always in the powered-on mode for faster access.

13. The secondary storage system of claim 1, further comprising:
a file-archiver mechanism configured to group data units in a storage medium in the secondary storage media when it is determined that the group is accessed together frequently.

14. The secondary storage system of claim 1, further comprising:
a powering on mechanism configured to transition the secondary storage medium at the lower power mode from the lower power mode to a powered-on mode based on a search of the metadata, wherein secondary storage medium being changed before a request for a data unit in the secondary storage medium is received.

15. A method for maintaining data units transferred from a primary storage system in a secondary storage system including secondary storage media, wherein not all of the secondary storage media is in a powered-on mode at the same time, wherein the secondary storage media includes at least one storage medium always in the powered-on mode, the method comprising:
determining metadata for one or more data units in secondary storage media in the secondary storage system, wherein metadata includes attributes for data units in at least one of the secondary storage media that is in a lower power mode than the at least one storage medium always in the powered-on mode; and
storing the metadata in the at least one storage medium always in the powered-on mode, wherein the attributes allow information about the data units in the at least one of the secondary storage medium that is at the lower power mode to be determined.

16. The method of claim 15, further comprising:
receiving a query from an interface; and
using an attribute for at least one of the one or more data units to provide information about a data unit.

17. The method of claim 16, wherein the attribute includes user-defined information that is used to provide information about the data unit.

18. The method of claim 17, further comprising providing a response to the query in real-time for a data unit in the one or more data units that is in the at least one of the storage media at the lower power mode.

19. The method of claim 16, wherein the attribute includes versioning information that is used to provide information about the data unit.

20. The method of claim 16, further comprising:
determining which storage media are in the powered-on mode; and
storing the metadata in one of the determined storage media in the powered-on mode.

21. The method of claim 16, further comprising:
determining how much open space is unallocated on a storage media in the powered-on mode; and
determining where to store the metadata based on the unallocated space.
